(19) United States
(12) Patent Application Publication
(10) Pub. No.: US 2003/0145109 A1
(43) Pub. Date: Jul. 31, 2003

(54) Front-end processor and a routing management method

(75) Inventor: Manabu Nakashima, Kawasaki (JP)

Correspondence Address: Patrick G. Burns, Esq., GREER, BURNS & CRAIN, LTD., 300 South Wacker Dr., Suite 2500, Chicago, IL, 60606, US

(73) Assignee: FUJITSU LIMITED

(21) Appl. No.: 10/314,636

(22) Filed: Dec. 9, 2002

(30) Foreign Application Priority Data
Jan. 28, 2002 (JP) 2002-18237

(51) Int. Cl. G06F 15/173; G06F 15/16

(52) U.S. Cl. 709/241; 709/249

(57) ABSTRACT

A front-end processor and a routing management method capable of appropriately controlling the loads on respective routing paths. An Allocating section allocates a router on a first network to a routing section, and a routing information transmitting section transmits routing information to the router allocated to the routing section. The router, which is thus supplied with the routing information, accesses a server computer via the routing section, whereby the processing load of the routing section can be appropriately controlled.

### BACKGROUND OF THE INVENTION

(1) Field of the Invention

The present invention relates to a front-end processor for routing packets between servers and clients and a routing management method therefor, and more particularly, to a front-end processor having a plurality of processor modules incorporated therein and a routing management method therefor.

(2) Description of the Related Art

With a host system constituted by a plurality of server computers (hereinafter merely referred to as servers), it is possible to provide services to a large number of client computers (hereinafter merely referred to as clients). The individual servers constituting the host system may have respective different functions, and in such cases, a computer called front-end processor (hereinafter abbreviated as FEP) is interposed between the host system and the clients.

The FEP takes care of routing packets between the servers and the clients. When routing packets, the FEP manages/distributes packets to be processed in a manner such that the users of the clients can make use of transactions, which are configured in compliance with the server-side design requirements or operation requirements, without taking notice of the locations of the transactions.

Where an FEP is provided between servers and clients in this manner, if the FEP stops its operation, then all services provided by the servers are disrupted. To cope with such a situation, the FEP has a plurality of processor modules (PMs) incorporated therein. Each processor module has the function (including the packet distribution function) of routing packets between the servers and the clients, whereby the operation of the host system can be stabilized.

In the conventional FEP having multiple PMs incorporated therein, however, the processing loads of the individual PMs cannot be properly controlled.

For example, in cases where the FEP carries out dynamic routing, all of routing information (RIP: Routing Information Protocol) for the individual servers is transmitted from the respective PMs. Which PM is used for communication depends on the choice of other routers that received the routing information (RIP). Since these routers take no account of the loads on the PMs in the FEP, there arises an imbalance of communication load among the PMs, with the result that the load fails to be equalized.

Also, in cases where massive amounts of data are continuously received from numerous originators at the same time, the conventional FEP tries to process as large an amount of the received data as possible, even if the amount of data to be processed is beyond the system capabilities. As a result, the FEP slows down as a whole, creating a situation where communications with all those involved fail to proceed normally.

### SUMMARY OF THE INVENTION

The present invention was created in view of the above circumstances, and an object thereof is to provide a front-end processor capable of appropriately controlling loads on individual routing paths, and a routing management method therefor.

To achieve the object, there is provided a front-end processor for routing packets. The front-end processor comprises routing means for routing packets input via a first network to a second network, allocating means for allocating a router on the first network to the routing means, and routing information transmitting means for transmitting routing information indicative of a communication path to a server computer on the second network via the routing means, to the router allocated by the allocating means.

Also, to achieve the above object, there is provided a routing management method for managing routing of packets from a first network to a second network. The routing management method comprises allocating a router on the first network to a relay path connecting between the first and second networks, and transmitting, to the allocated router, routing information indicative of a communication path to a server computer on the second network via the relay path.

The present invention further provides a routing management program for managing routing of packets from a first network to a second network. The routing management program causes a computer to perform the process of allocating a router on the first network to a relay path connecting between the first and second networks, and transmitting, to the allocated router, routing information indicative of a communication path to a server computer on the second network via the relay path.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual diagram illustrating the invention applied to embodiments;

FIG. 2 is a diagram showing a system configuration according to an embodiment of the present invention;

FIG. 3 is a block diagram showing an internal configuration of an FEP;

FIG. 4 is a diagram illustrating a state transition at the time of allocation of routers to corresponding PMs;

FIG. 5 is a diagram illustrating a state transition at the time when the load on one PM has become excessively high;

FIG. 6 is a diagram illustrating a state transition at the time when the overall load on the FEP has become excessively high;

FIG. 7 is a functional block diagram illustrating the processing function of the PMs in the FEP;

FIG. 8 is a block diagram illustrating in detail the function of a load control section;

FIG. 9 is a diagram showing an exemplary data structure of a router allocation definition table;

FIG. 10 is a diagram showing an exemplary data structure of a load information management table;

FIG. 11 is a diagram showing an exemplary data structure of a router priority order table;

FIG. 12 is a flowchart illustrating a procedure for transmitting routing information to the routers allocated to the PMs;

FIG. 13 is a flowchart illustrating a router reallocation procedure;

FIG. 14 is a diagram showing an example of routing information which a PM transmits to a router allocated thereto;

FIG. 15 is a diagram showing an example of routing information which a PM transmits to a router reallocated thereto from a different PM; and

FIG. 16 is a diagram showing an example of routing information transmitted to a router whose packets are to be discarded.

### DESCRIPTION OF THE PREFERRED EMBODIMENTS

Embodiments of the present invention will be hereinafter described with reference to the drawings.

First, the inventive concept applied to the embodiments will be outlined, and then specific embodiments of the present invention will be described in detail.

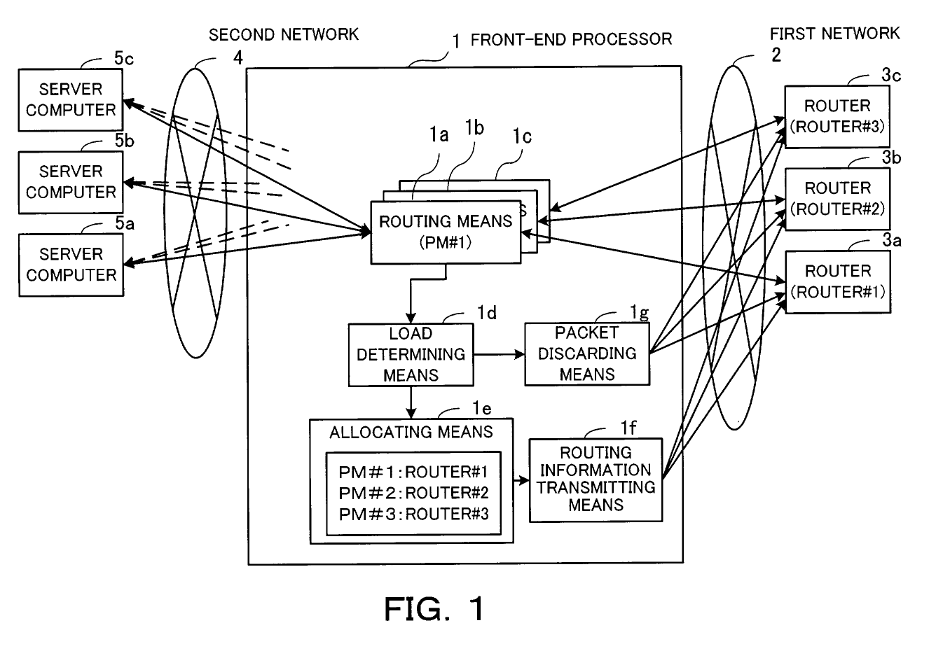

FIG. 1 is a conceptual diagram illustrating the invention applied to the embodiments. A front-end processor 1 according to the present invention is connected to a plurality of routers 3a to 3c through a first network 2. In the example shown in FIG. 1, identification information of the router 3a is indicated by “ROUTER#1,” identification information of the router 3b is indicated by “ROUTER#2,” and identification information of the router 3c is indicated by “ROUTER#3.”

The front-end processor 1 is also connected to a plurality of server computers 5a to 5c through a second network 4. The front-end processor 1 routes packets transmitted from the first network 2 to the second network 4. To this end, the front-end processor 1 has a plurality of routing means la to 1c, load determining means 1d, allocating means 1e, routing information transmitting means 1f, and packet discarding means 1g.

The routing means 1a to 1c individually route packets input via the first network 2 to the second network 4. Namely, each of the routing means 1a to 1c constitutes a separate relay path for routing. At the time of routing, the routing means 1a to 1c distribute packets to those server computers which are fit for processes requested by the respective packets.

The routing means 1a to 1c are each constituted, for example, by a module called processor module. In the example of FIG. 1, identification information of the routing means 1a is indicated by “PM#1,” identification information of the routing means 1b is indicated by “PM#2,” and identification information of the routing means 1c is indicated by “PM#3.”

The load determining means 1d monitors the loads on the routing means 1a to 1c, and determines whether or not any of the loads on the routing means 1a to 1c has exceeded a predetermined value. Also, the load determining means 1d determines whether or not the overall load on the front-end processor 1 has exceeded a predetermined value.

The allocating means 1e allocates the routers on the first network 2 to the routing means 1a to 1c. The allocation is represented, for example, by correlation of the identification information between the routing means 1a to 1c and the routers 3a to 3c. In the example of FIG. 1, the router 3a is allocated to the routing means 1a, the router 3b is allocated to the routing means 1b, and the router 3c is allocated to the routing means 1c.

The routing information transmitting means 1f transmits routing information indicative of communication paths to the server computers 5a to 5c on the second network 4 via the routing means 1a to 1c, to the corresponding routers 3a to 3c allocated by the allocating means 1e. Specifically, the routing information indicative of the communication path via the routing means 1a is transmitted to the router 3a. The routing information indicative of the communication path via the routing means 1b is transmitted to the router 3b, and the routing information indicative of the communication path via the routing means 1c is transmitted to the router 3c.

Also, the routing information transmitting means 1f is capable of reallocating a router allocated to the routing means whose load is judged to have exceeded the predetermined value (high load) by the load determining means id, to another routing means.

If it is judged that the overall load on the front-end processor 1 has exceeded the predetermined value (high load), the packet discarding means 1g discards at least part of packets from a certain router (e.g. a prespecified router of low priority). Also, if it is judged that the load on any of the routing means 1a to 1c has exceeded the predetermined value (high load), the packet discarding means 1g discards at least part of packets from the router allocated to the routing means concerned.

When discarding packets, the packet discarding means 1g transmits routing information indicative of a path via routing means that actually does not exist, for example, to the router whose packets are to be discarded. Thus, on receiving the routing information, the router redirects packets to the nonexistent routing means, and therefore, the packets are discarded.

In the front-end processor 1 configured as above, the routing information indicative of the path via the individual routing means 1a to 1c is not broadcast, but is transmitted only to the corresponding router allocated by the allocating means 1e. Each of the routers 3a to 3c cannot access the server computers 5a to 5c but via the path notified by means of the routing information and, therefore, accesses the server computers 5a to 5c via that one of the routing means 1a to 1c which has been allocated by the allocating means 1e. This permits the load balance among the routing means 1a to 1c to be managed by the front-end processor 1.

For example, the number of routers allocated to an excessively loaded routing means is reduced, whereby the load on this routing means can be lightened.

Also, if the overall load on the front-end processor 1 has become excessively high, packets output from an optional router are discarded by the packet discarding means 1g, thereby preventing the processing speed of the system as a whole from being lowered. For example, in cases where massive amounts of packets are continuously received from numerous routers at the same time, packets sent from a certain router are discarded, thus making it possible to avoid the function being lowered by the reception of massive packets.

In this manner, the relay path for packets from any one of the routers 3a to 3c is switched from high loaded routing means to low loaded routing means, and if such switching fails to relieve the load, the packet discarding process is performed to control the total amount of data received, whereby the operation of the system can be stabilized.

A specific embodiment of the present invention will be now described in detail.

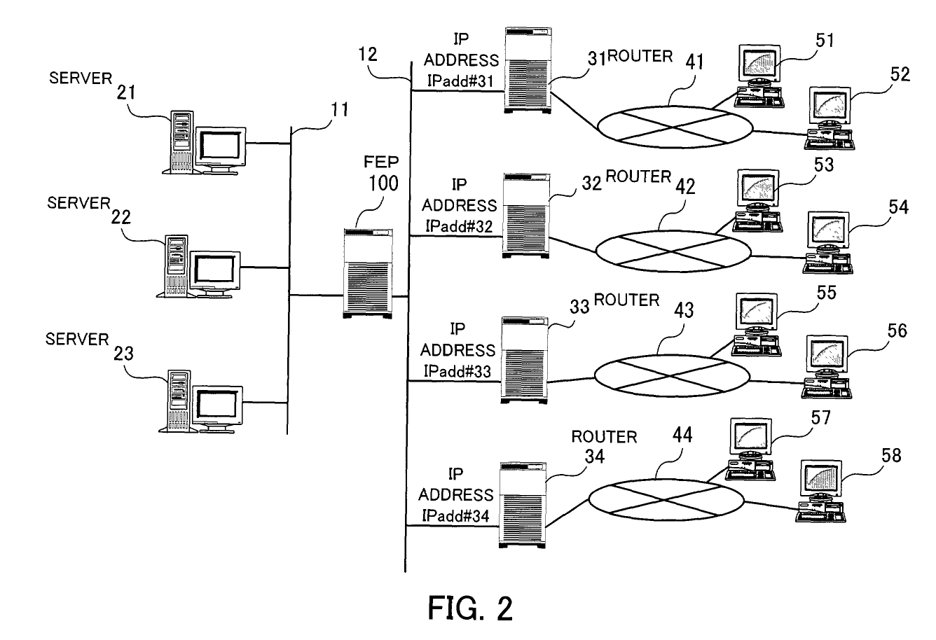

FIG. 2 shows a system configuration according to the embodiment of the present invention. As shown in FIG. 2, a front-end processor (FEP) 100 is interposed between two networks 11 and 12. A plurality of servers 21 to 23 are connected to the network 11, and a plurality of routers 31 to 34 are connected to the network 12. The router 31 is connected via a network 41 to a plurality of clients 51 and 52. Similarly, the router 32 is connected via a network 42 to a plurality of clients 53 and 54, and the router 33 is connected via a network 43 to a plurality of clients 55 and 56. The router 34 is connected via a network 44 to a plurality of clients 57 and 58.

The FEP 100 provides the routers 31 to 34 with routing information indicative of communication paths to the servers 21 to 23. Also, on receiving packets requesting processes by the servers 21 to 23 from the clients 51 to 58 via the routers 31 to 34, the FEP 100 distributes the packets to appropriate servers in accordance with the respective functions of the servers 21 to 23.

The servers 21 to 23 constitute a host system for providing processing functions to the clients 51 to 58. Each of the servers 21 to 23 receives packets requesting processes thereby from the clients 51 to 58 via the FEP 100, and carries out various processes in accordance with the packets.

The routers 31 to 34 serve as relay devices for connecting targets of communication (clients 51 to 58) and the FEP 100. In accordance with the routing information transmitted from the FEP 100, the routers 31 to 34 transfer packets output from the clients 51 to 58 to the FEP 100. Also, the routers 31 to 34 are individually supplied with routing information (RIP: Routing Information Protocol) and ARP (Address Resolution Protocol), so that the individual routers can recognize IP addresses and MAC addresses of the devices connected via the network 12 and the respective networks 41 to 44. The IP address of the network 12 side of the router 31 is “IPadd#31,” and the IP address of the network 12 side of the router 32 is “IPadd#32.” The IP address of the network 12 side of the router 33 is “IPadd#33,” and the IP address of the network 12 side of the router 34 is “IPadd#34.”

The clients 51 to 58 are grouped by purpose, use, location, etc. In response to a user's input operation, each of the clients 51 to 58 outputs a packet via the relay device (routers 31 to 34) provided exclusively for the group to which it belongs, to request processing by the host system constituted by the multiple servers 21 to 23. The packet is distributed by the FEP 100, so that communications between the clients 51 to 58 and the servers 21 to 23 can be performed.

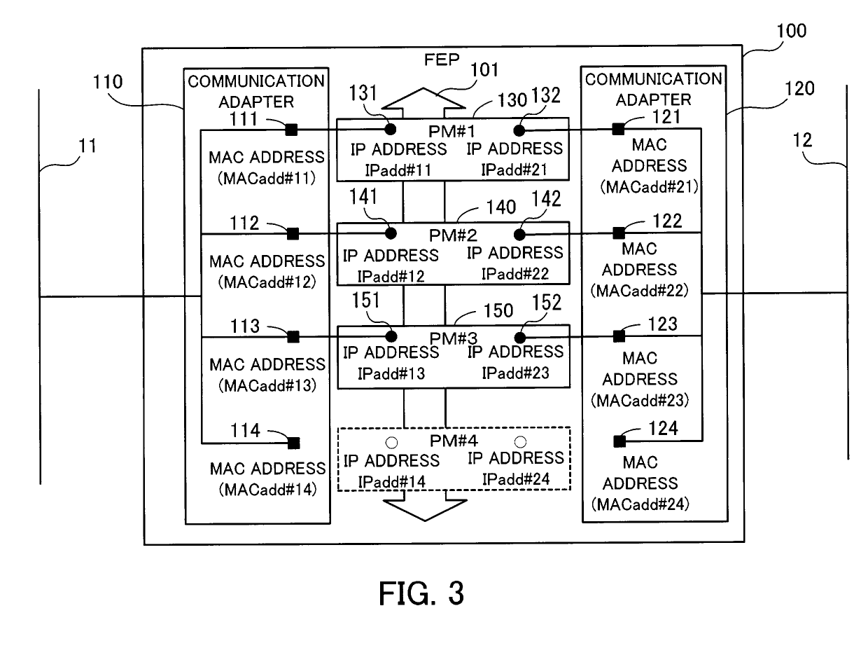

FIG. 3 is a block diagram showing an internal configuration of the FEP. The FEP 100 has two communication adapters 110 and 120, and a plurality of processor modules (PMs) 130, 140 and 150. Each of the PMs 130, 140 and 150 has identification information set therein. The identification information of the PM 130 is indicated by “PM#1.” The identification information of the PM 140 is indicated by “PM#2,” and the identification information of the PM 150 by “PM#3.” Also defined in the FEP 100 is identification information “PM#4” of a PM that actually does not exist.

The communication adapter 110 is connected to the network 11 and has connection ports 111 to 114 for connection with the PMs 130, 140 and 150. The communication adapter 110 exchanges packets between the PMs 130, 140 and 150 and the network 11.

Also, the communication adapter 110 has a plurality of MAC addresses (physical addresses) defined therein such that one MAC address is assigned to each of the connection ports 111 to 114 for connection with the PMs 130, 140 and 150. In the example shown in FIG. 3, the MAC address “MACadd#11” is assigned to the connection port 111 connected to the PM 130. The MAC address “MACadd#12” is assigned to the connection port 112 connected to the PM 140, and the MAC address “MACadd#13” is assigned to the connection port 113 connected to the PM 150. The communication adapter 110 also assigns the MAC address “MACadd#14” to the connection port 114 corresponding to the nonexistent PM (PM#4).

The communication adapter 120 is connected to the network 12 and has connection ports 121 to 124 for connection with the PMs 130, 140 and 150. The communication adapter 120 exchanges packets between the PMs 130, 140 and 150 and the network 12.

Also, the communication adapter 120 has a plurality of MAC addresses defined therein such that one MAC address is assigned to each of the connection ports 121 to 124 for connection with the PMs 130, 140 and 150. In the example of FIG. 3, the MAC address “MACadd#21” is assigned to the connection port 121 connected to the PM 130. The MAC address “MACadd#22” is assigned to the connection port 122 connected to the PM 140, and the MAC address “MACadd#23” is assigned to the connection port 123 connected to the PM 150. The communication adapter 120 also assigns the MAC address “MACadd#24” to the connection port 124 corresponding to the nonexistent PM (PM#4).

The PMs 130, 140 and 150 each have a CPU (Central Processing Unit), a RAM (Random Access Memory), etc. built therein and function as an independent computer. Also, the PMs 130, 140 and 150 are interconnected by a bus 101 and thus can communicate with each other. Each of the PMs 130, 140 and 150 has two communication ports, one communication port 131, 141, 151 being connected to the communication adapter 110 while the other communication port 132, 142, 152 being connected to the communication adapter 120.

In the PMs 130, 140 and 150, the individual communication ports 131, 132, 141, 142, 151 and 152 are assigned respective IP addresses. In the PM 130, the IP address “IPadd#11” is assigned to the communication port 131 connected to the communication adapter 110, and the IP address “IPadd#21” is assigned to the communication port 132 connected to the communication adapter 120. Similarly, in the PM 140, the IP address “IPadd#12” is assigned to the communication port 141 connected to the communication adapter 110, and the IP address “IPadd#22” is assigned to the communication port 142 connected to the communication adapter 120. In the PM 150, the IP address “IPadd#13” is assigned to the communication port 151 connected to the communication adapter 110, and the IP address “IPadd#23” is assigned to the communication port 152 connected to the communication adapter 120.

In the FEP 100, IP addresses are also set for the PM (PM#4) that actually does not exist. Specifically, for this nonexistent PM (PM#4), the IP address “IPadd#14” is assigned to the communication port corresponding to the communication adapter 110, and the IP address “IPadd#24” is assigned to the communication port corresponding to the communication adapter 120.

The definition about the nonexistent PM (PM#4) is stored in one of the actually existing PMs 130, 140 and 150.

The processing function of each of the PMs 130, 140 and 150 in the FEP 100 will be now described.

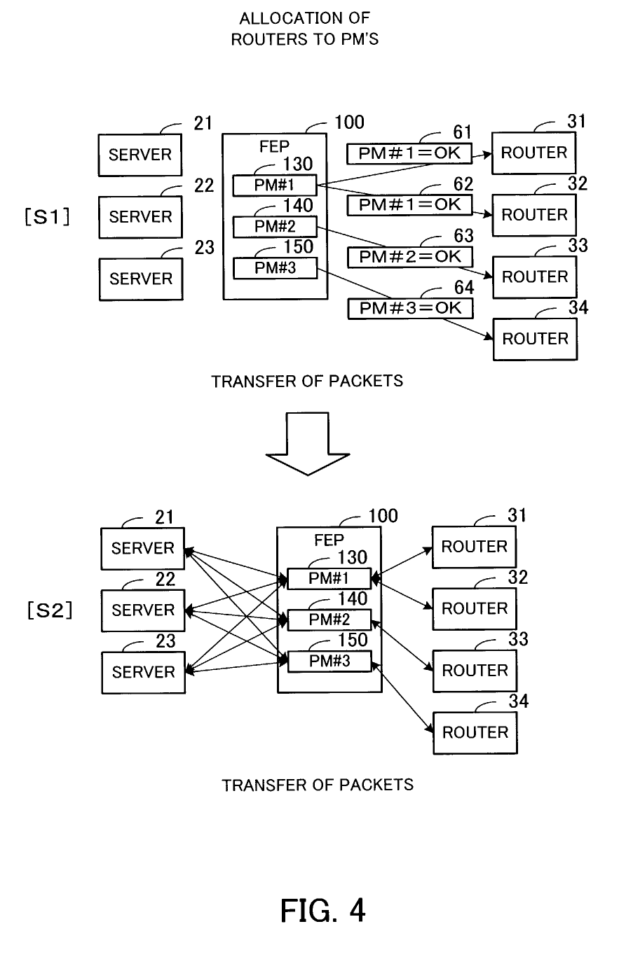

Referring first to FIGS. 4 to 6, conceptual state transitions during packet transfer according to this embodiment will be explained. In the FEP 100 of this embodiment, the routing information is modified and thus the packet transfer path is changed when the routers are allocated to the PMs, when the load on a certain PM has become excessively high, or when the overall load on the FEP has become excessively high.

FIG. 4 illustrates a state transition at the time of allocation of the routers to the individual PMs.

[Step S1] The routers 31 to 34 are allocated to the PMs 130, 140 and 150, whereupon the routing information is transmitted from the PMs 130, 140 and 150 to the routers 31 to 34. In the example shown in FIG. 4, the routers 31 and 32 are allocated to the PM 130, the router 33 is allocated to the PM 140, and the router 34 is allocated to the PM 150. In this case, the PMs 130, 140 and 150 transmit only to the router(s) allocated thereto routing information 61 to 64 indicating that the servers 21 to 23 are connected via the respective PMs 130, 140 and 150. Specifically, the PM 130 transmits, to the routers 31 and 32, the routing information 61 and 62 indicating that the servers 21 to 23 are connected via the PM 130. Similarly, the PM 140 transmits to the router 33 the routing information 63 indicating that the servers 21 to 23 are connected via the PM 140, and the PM 150 transmits to the router 34 the routing information 64 indicating that the servers 21 to 23 are connected via the PM 150.

[Step S2] The routers 31 to 34 transmit packets to the servers 21 to 23 via the corresponding PMs 130, 140 and 150 from which the routing information indicative of the paths to the servers 21 to 23 has been received. Specifically, the routers 31 and 32 transmit packets to the servers 21 to 23 via the PM 130, the router 33 transmits packets to the servers 21 to 23 via the PM 140, and the router 34 transmits packets to the servers 21 to 23 via the PM 150.

In this manner, each of the PMs 130, 140 and 150 transmits the routing information only to the router or routers allocated thereto, whereby the FEP 100 can control the relay paths to which the respective routers 31 to 34 transmit packets destined for the servers 21 to 23. This prevents packets transmitted from numerous routers 31 to 34 from concentrating at a certain PM. Namely, the loads on the individual PMs can be appropriately distributed under the control of the FEP 100.

If the load on a certain PM becomes excessively high thereafter, a router allocated to this PM is reallocated to another PM.

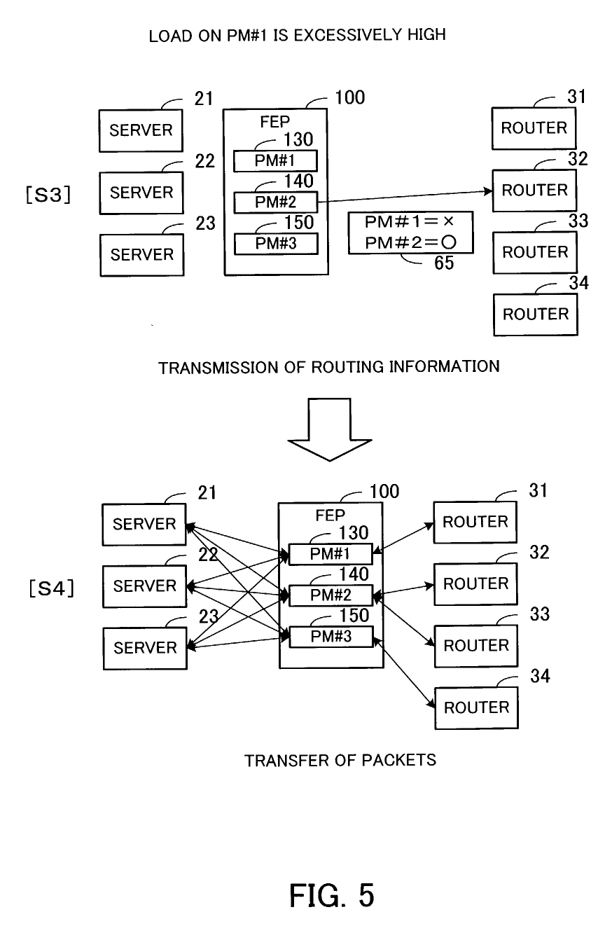

FIG. 5 illustrates a state transition at the time when the load on a certain PM has become excessively high.

[Step S3] If the load on the PM 130, for example, becomes excessively high, routing information 65 requesting change of the packet transfer path is transmitted to the router 32 which has been allocated to the PM 130 so far. In the example of FIG. 5, the routing information 65 is transmitted from the PM 140 to the router 32. The routing information 65 indicates that the servers 21 to 23 are connected not via the PM 130 but via the PM 140.

[Step S4] The PM as the relay path to which the router 32 transmits packets destined for the servers 21 to 23 is changed. The other routers 31, 33 and 34 transmit packets via the same paths as before. Specifically, the router 31 transmits packets to the servers 21 to 23 via the PM 130, the routers 32 and 33 transmit packets to the servers 21 to 23 via the PM 140, and the router 34 transmits packets to the servers 21 to 23 via the PM 150.

Thus, when the load on a certain PM has become excessively high, the number of routers allocated to the PM is reduced and a router allocated to this PM so far is reallocated to a different PM, whereby the load can be dynamically distributed among a plurality of PMs.

If the overall load on the FEP 100 becomes excessively high thereafter, packets from a router of lowest priority are discarded.

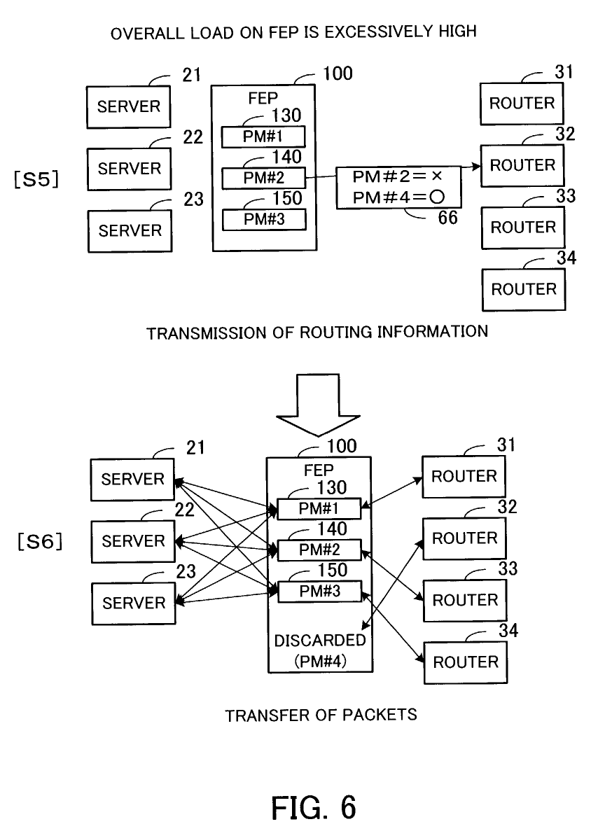

FIG. 6 illustrates a state transition at the time when the overall load on the FEP has become excessively high.

[Step S5] Assuming that the router 32, for example, has the lowest priority among the routers, if the overall load on the FEP 100 becomes excessively high, routing information 66 requesting change of the packet transfer path to the nonexistent PM is transmitted to the router 32. In the example of FIG. 6, the routing information 66 is transmitted from the PM 140 to the router 32. The routing information 66 indicates that the servers 21 to 23 are connected not via the PM 140 but via the nonexistent PM (PM#4).

[Step S6] The PM as the relay path to which the router 32 transmits packets destined for the servers 21 to 23 is changed, while the other routers 31, 33 and 34 transmit packets via the same paths as before. Specifically, the router 31 transmits packets to the servers 21 to 23 via the PM 130, the router 32 transmits packets to the nonexistent PM (PM#4), the router 33 transmits packets to the servers 21 to 23 via the PM 140, and the router 34 transmits packets to the servers 21 to 23 via the PM 150.

In this manner, the router 32 is caused to transmit packets to the PM (PM#4) that actually does not exist, so that the packets received via the router 32 are discarded. Namely, when the overall load on the FEP 100 has become excessively high, packets received via an optional router are discarded, whereby the function of the FEP 100 is prevented from being lowered due to too high a load applied to the FEP 100 as a whole.

The aforementioned processes are accomplished by the function of the FEP 100 as described below.

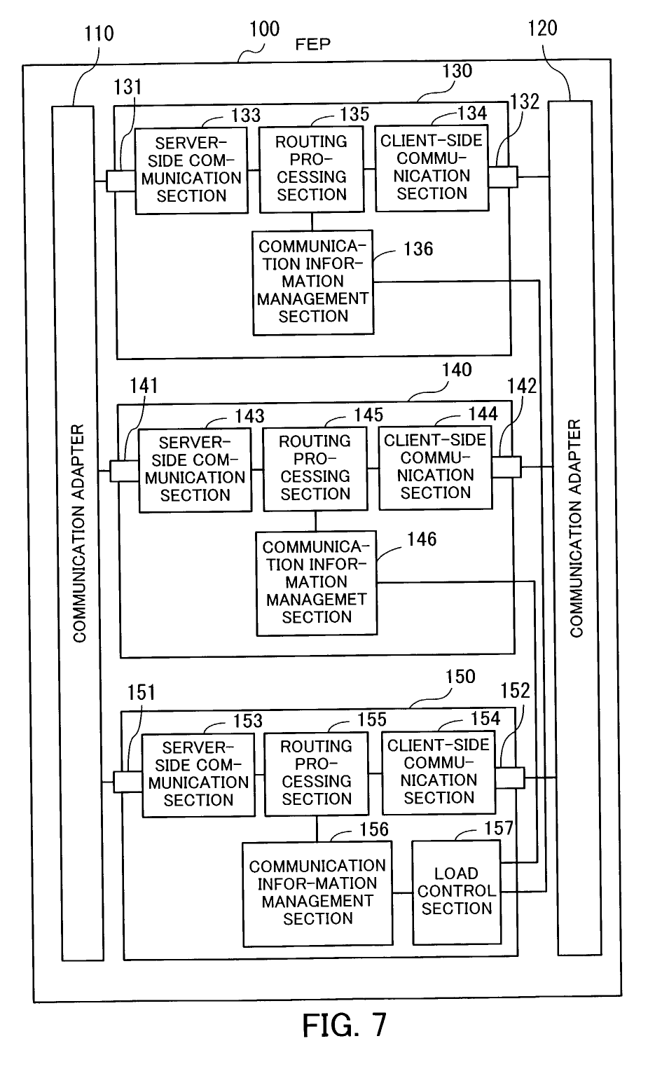

FIG. 7 is a functional block diagram illustrating the processing function of the PMs in the FEP. The PM 130 comprises communication ports 131 and 132, a server-side communication section 133, a client-side communication section 134, a routing processing section 135, and a communication information management section 136. The server-side communication section 133 is connected to the network 11 via the communication port 131 and controls communications via the network 11. The client-side communication section 134 is connected to the network 12 via the communication port 132 and controls communications via the network 12.

The routing processing section 135 is connected to the server-side and client-side communication sections 133 and 134, and performs a process of routing packets between these communication sections 133 and 134. When routing a packet received from the client-side communication section 134, the routing processing section 135 checks the capacities etc. of the individual servers connected to the network 11, to determine the destination to which the packet is to be distributed. Then, the routing processing section 135 sets the address of the server thus determined as the destination of the packet, and transfers the packet to the server-side communication section 133.

The routing processing section 135 does not broadcast the routing information (RIP) indicative of communication paths to the servers 21 to 23, but transmits the routing information only to the router(s) notified from the communication information management section 136. Specifically, the routing processing section 135 receives the IP address(es) of a router(s) allocated to the PM 130 from the communication information management section 136, and generates routing information indicative of communication paths to the servers 21 to 23 via the PM 130. Then, using the IP address(es) of the router(s) allocated to the PM 130 as a destination(s) of the routing information, the routing processing section 135 transfers the routing information to the client-side communication section 134.

Also, the routing processing section 135 outputs a variety of routing information, generated at the request of the communication information management section 136, to the network 12 via the client-side communication section 134. For example, on receiving a request from the communication information management section 136 to reallocate a router which has been allocated to another PM so far to the PM 130, the routing processing section 135 generates routing information requesting the reallocation. This routing information indicates that the router concerned can no longer communicate via the original PM to which the router has been allocated so far and can communicate via the PM 130.

Further, on receiving a request from the communication information management section 136 to discard packets output from a certain router, the routing processing section 135 generates routing information requesting discard of the packets. In this case, the routing information indicates that the router concerned can no longer communicate via the original PM to which the router has been allocated so far and can communicate via the PM (PM#4) that actually does not exist.

The communication information management section 136 monitors the process performed by the routing processing section 135, and supplies information indicative of the status of processing by the routing processing section 135 to a load control section 157 in the PM 150. The information indicative of the processing status includes, for example, the number of connections established via the routing processing section 135 and the number of packets relayed per unit time by the routing processing section 135.

Also, on receiving information about router allocation from the load control section 157, the communication information management section 136 notifies the routing processing section 135 of the IP address of the allocated router. If the router then allocated has been allocated to a different PM, the communication information management section 136 also notifies the routing processing section 135 of the IP address of the previously allocated PM. Further, when instructed from the load control section 157 to discard packets output from a certain router, the communication information management section 136 transfers the packet discard request specifying the IP address of the router concerned to the routing processing section 135.

The PM 140 comprises communication ports 141 and 142, a server-side communication section 143, a client-side communication section 144, a routing processing section 145, and a communication information management section 146. The server-side communication section 143 is connected via the communication port 141 to the network 11 and controls communications via the network 11. The client-side communication section 144 is connected via the communication port 142 to the network 12 and controls communications via the network 12. The routing processing section 145 has the same function as the routing processing section 135 of the PM 130, and also the communication information management section 146 has the same function as the communication information management section 136 of the PM 130.

The PM 150 comprises communication ports 151 and 152, a server-side communication section 153, a client-side communication section 154, a routing processing section 155, a communication information management section 156, and the load control section 157. The server-side communication section 153 is connected via the communication port 151 to the network 11 and controls communications via the network 11. The client-side communication section 154 is connected via the communication port 152 to the network 12 and controls communications via the network 12. The routing processing section 155 has the same function as the routing processing section 135 of the PM 130, and also the communication information management section 156 has the same function as the communication information management section 136 of the PM 130.

The load control section 157 is connected to the communication information management sections 136, 146 and 156 of the respective PMs 130, 140 and 150. The load control section 157 collects information about the routing processing status from the individual communication information management sections 136, 146 and 156 and, based on the collected information, determines the processing loads of the respective PMs 130, 140 and 150.

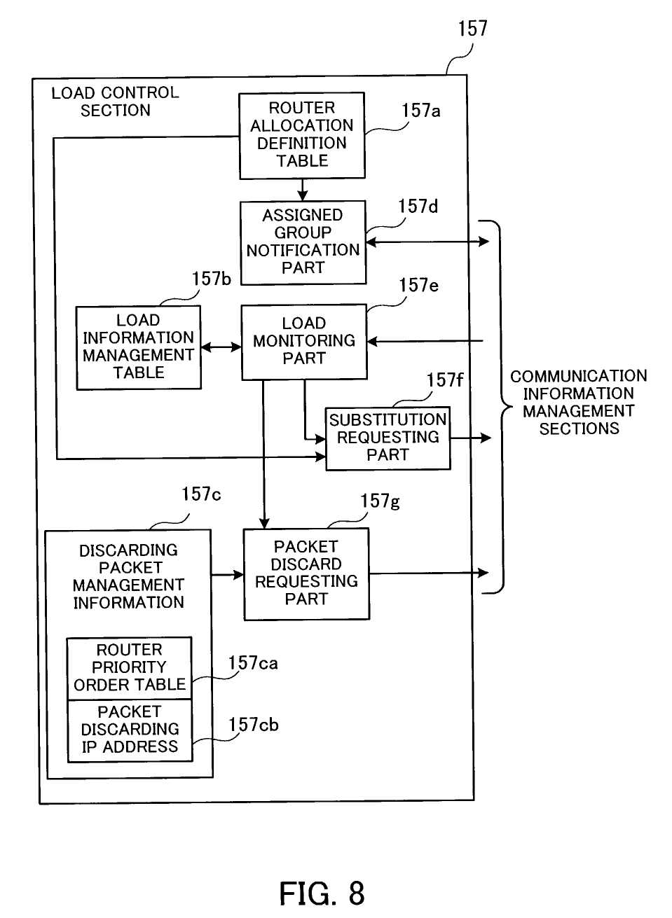

FIG. 8 is a block diagram illustrating in detail the function of the load control section. The load control section 157 has a router allocation definition table 157a, a load information management table 157b, discarding packet management information 157c, an assigned group notification part 157d, a load monitoring part 157e, a substitution requesting part 157f, and a packet discard requesting part 157g.

The router allocation definition table 157a has previously set therein the IP addresses of the routers to be allocated to the PMs 130, 140 and 150.

In the load information management table 157b is registered information about the throughputs, allowable loads and present loads of the respective PMs 130, 140 and 150.

The discarding packet management information 157c includes a router priority order table 157ca and an IP address 157cb for discarding packets. The router priority order table 157ca has set therein the order of priority in which the routers should be kept in a state capable of communication. As the packet discarding IP address 157cb, an IP address is set which is the destination of packets to be discarded. In this embodiment, the IP address “IPadd#24” of the nonexistent PM (PM#4) is set as the packet discarding IP address 157cb.

The assigned group notification part 157d is connected to the router allocation definition table 157a and the communication information management sections 136, 146 and 156 of the respective PMs 130, 140 and 150. The assigned group notification part 157d looks up the router allocation definition table 157a, and notifies the communication information management sections 136, 146 and 156 of the IP addresses of the routers allocated to the corresponding PMs 130, 140 and 150.

The load monitoring part 157e is connected to the load information management table 157b and the communication information management sections 136, 146 and 156 of the respective PMs 130, 140 and 150. The load monitoring part 157e collects information about the processing status (number of connections, number of packets relayed per unit time) etc. of the individual PMs 130, 140 and 150 from the corresponding communication information management sections 136, 146 and 156, and registers the collected information in the load information management table 157b. Also, the load monitoring part 157e looks up the load information management table 157b to determine whether or not the overall load on the FEP 100 is higher than an allowable value and whether or not there exists a PM whose load has exceeded an allowable value.

If the overall load on the FEP 100 has exceeded the allowable value, the load monitoring part 157e requests the packet discard requesting part 157g to reduce the load. On the other hand, if there is a PM whose load has exceeded the allowable value, the load monitoring part 157e requests the substitution requesting part 157f to reduce the load on the PM concerned. When requesting the load reduction, the load monitoring part 157e looks up the load information management table 157b to select a PM whose load is well below the allowable value, and supplies information specifying the selected PM to the substitution requesting part 157f or the packet discard requesting part 157g.

On receiving the request from the load monitoring part 157e to reduce the load on the PM whose load has exceeded the allowable value, the substitution requesting part 157f looks up the router allocation definition table 157a and acquires the IP address of the router allocated to the PM whose load has exceeded the allowable value. The substitution requesting part 157f then requests the PM whose load is well below the allowable value to act as a substitute. The request for substitution includes a notification that the router allocated to the PM whose load has exceeded the allowable value should be reallocated to the different PM whose load is well below the allowable value. More specifically, the IP address of the port on the communication adapter 120 side of the PM whose load has exceeded the allowable value and the IP address of the router allocated to this PM are notified as the substitution request.

When the overall load on the FEP 100 has exceeded the allowable value and thus the packet discard requesting part 157g is supplied with a load reduction request from the load monitoring part 157e, the packet discard requesting part 157g looks up the router priority order table 157ca of the discarding packet management information 157c. The packet discard requesting part 157g then acquires, from the router priority order table 157ca, the IP address of the router having the lowest priority among those routers whose packets are not currently discarded.

Further, the packet discard requesting part 157g looks up the discarding packet management information 157c and acquires the IP address registered as the packet discarding IP address 157cb. Subsequently, the packet discard requesting part 157g sends a packet discard request to the PM whose load is well below the allowable value. The packet discard request includes the IP address of the router with the lowest priority, acquired from the router priority order table 157ca, and the packet discarding IP address.

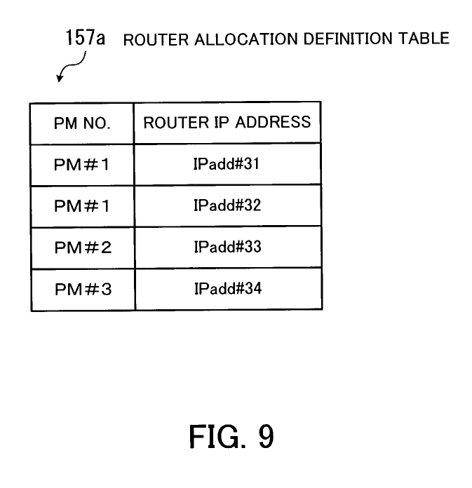

FIG. 9 shows an exemplary data structure of the router allocation definition table. The router allocation definition table 157a has a column for PM numbers and a column for router IP addresses. Items of information in each row across the columns are interrelated with each other.

In the “PM NO.” column, the identification numbers of the PMs 130, 140 and 150 incorporated in the FEP 100 are registered, and in the “ROUTER IP ADDRESS” column, the IP addresses of the routers allocated to the corresponding PMs 130, 140 and 150 are registered.

In the example shown in FIG. 9, the router 31 with the IP address “IPadd#31” and the router 32 with the IP address “IPadd#32” are allocated to the PM 130 with the PM number “IPM#1”. The router 33 with the IP address “IPadd#33” is allocated to the PM 140 with the PM number “PM#2,” and the router 34 with the IP address “IPadd#34” is allocated to the PM 150 with the PM number “PM#3.”

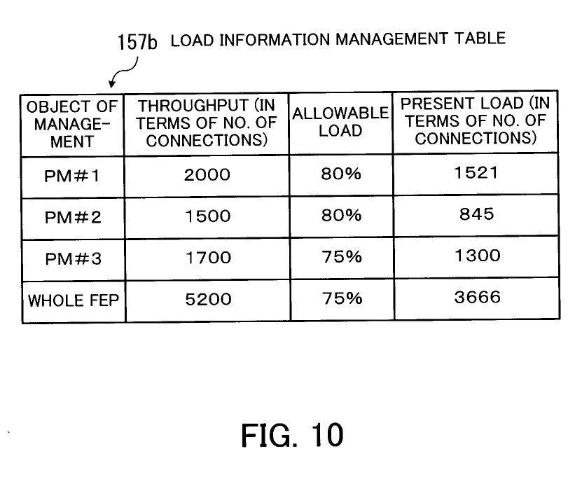

FIG. 10 shows an exemplary data structure of the load information management table. The load information management table 157b has columns for objects of management, throughputs, allowable loads, and present loads. Items of information in each row across the columns are associated with one another.

In the “OBJECT OF MANAGEMENT” column, the identification numbers of the PMs 130, 140 and 150 incorporated in the FEP 100 or information specifying the whole FEP is registered. In the “THROUGHPUT” column are registered the throughputs of the respective PMs 130, 140 and 150 in terms of the number of connections. In the “ALLOWABLE LOAD” column, allowable values of loads under which the respective PMs 130, 140 and 150 can smoothly perform process are indicated as percentages of the respective throughputs. In the “PRESENT LOAD” column are registered present processing loads of the respective PMs 130, 140 and 150 in terms of the number of connections. When converting an actual process into the number of connections, 100 packets, for example, are regarded as equivalent to one connection.

In the example of FIG. 10, the PM 130 with the PM number “PM#1” has a throughput of “2000 (connections),” the allowable load thereof is “80% (1600 connections),” and the present load thereof is “1521 (connections).” The PM 140 with the PM number “PM#2” has a throughput of “1500 (connections),” the allowable load thereof is “80% (1200 connections),” and the present load thereof is “845 (connections).” The PM 150 with the PM number “PM#3” has a throughput of “1700 (connections),” the allowable load thereof is “75% (1275 connections),” and the present load thereof is “1300 (connections).” The FEP 100 as a whole has a throughput of “5200 (connections),” the allowable load thereof is “75% (3900 connections),” and the present load thereof is “3666 (connections).”

In the illustrated example, the present load on the PM 150 is higher than the allowable load, and it is therefore necessary that the router 34 allocated to this PM 150 should be reallocated to a different PM. The throughputs of the individual PMs 130, 140 and 150 vary depending on the capacity of memory mounted thereon, etc.

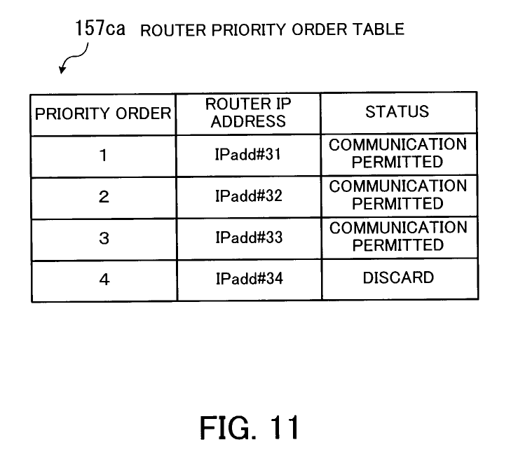

FIG. 11 shows an exemplary data structure of the router priority order table. The router priority order table 157ca has a column for priority order, a column for router IP addresses, and a column for status. Items of information in each row across the columns are associated with one another.

In the “PRIORITY ORDER” column are registered numerical values indicating the priority levels set for the respective routers. In the illustrated example, a smaller numerical value represents a higher priority level. In the “ROUTER IP ADDRESS” column, the IP addresses of the routers corresponding to the respective priority levels are registered. In the “STATUS” column are registered the statuses of the routers corresponding to the respective priority levels. The status includes “COMMUNICATION PERMITTED” and “DISCARD.” While a router is capable of transmitting packets to the host system, “COMMUNICATION PERMITTED” is set as the status of this router. While packets output from a router are discarded, “DISCARD” is set as the status of this router.

The process executed by the FEP 100 configured as above will be now described in detail.

First, the process of transmitting the routing information to the routers allocated to the corresponding PMs will be explained.

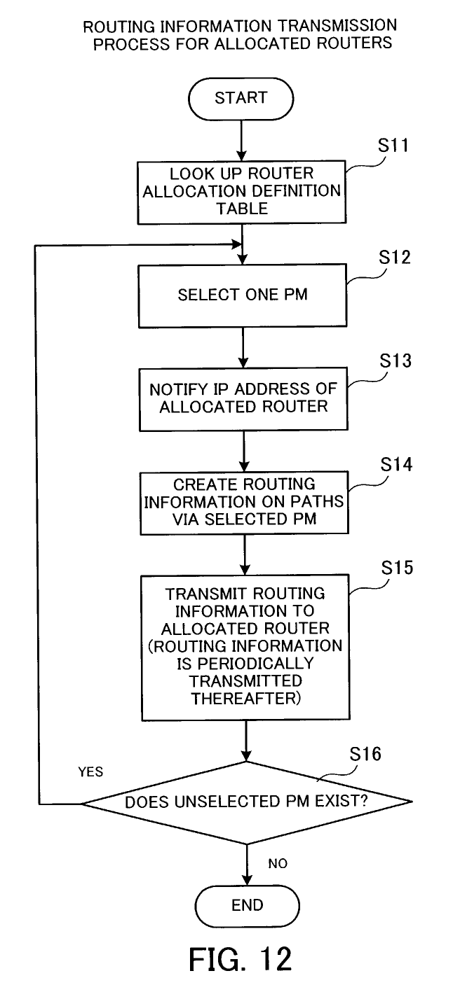

FIG. 12 is a flowchart illustrating a procedure for transmitting the routing information to the routers allocated to the PMs. In the following, the process shown in FIG. 12 will be explained in order of the step number. This process is executed when the FEP 100 is started, for example.

[Step S11] The assigned group notification part 157d of the load control section 157 looks up the router allocation definition table 157a.

[Step S12] The assigned group notification part 157d selects one PM which is not selected yet, from the router allocation definition table 157a.

[Step S13] The assigned group notification part 157d sends the IP address of the router allocated to the PM selected in Step S12, to the communication information management section of the selected PM.

[Step S14] On receiving the IP address of the router, the communication information management section transfers the IP address of the router to the routing processing section. Using the thus-transferred IP address as a destination, the routing processing section generates routing information indicative of communication paths to the respective servers 21 to 23 connected to the network 11.

[Step S15] The routing processing section transfers the generated routing information to the client-side communication section. The client-side communication section transmits the routing information to the router allocated to the PM. The routing processing section thereafter periodically (e.g. at intervals of 30 seconds) transmits the routing information to the router allocated to the PM.

[Step S16] The assigned group notification part 157d of the load control section 157 determines whether or not there exists an unselected PM. If an unselected PM exists, the flow proceeds to Step S12; if there is no unselected PM, the process is ended.

The process of reallocating a router in accordance with the processing load will be now described.

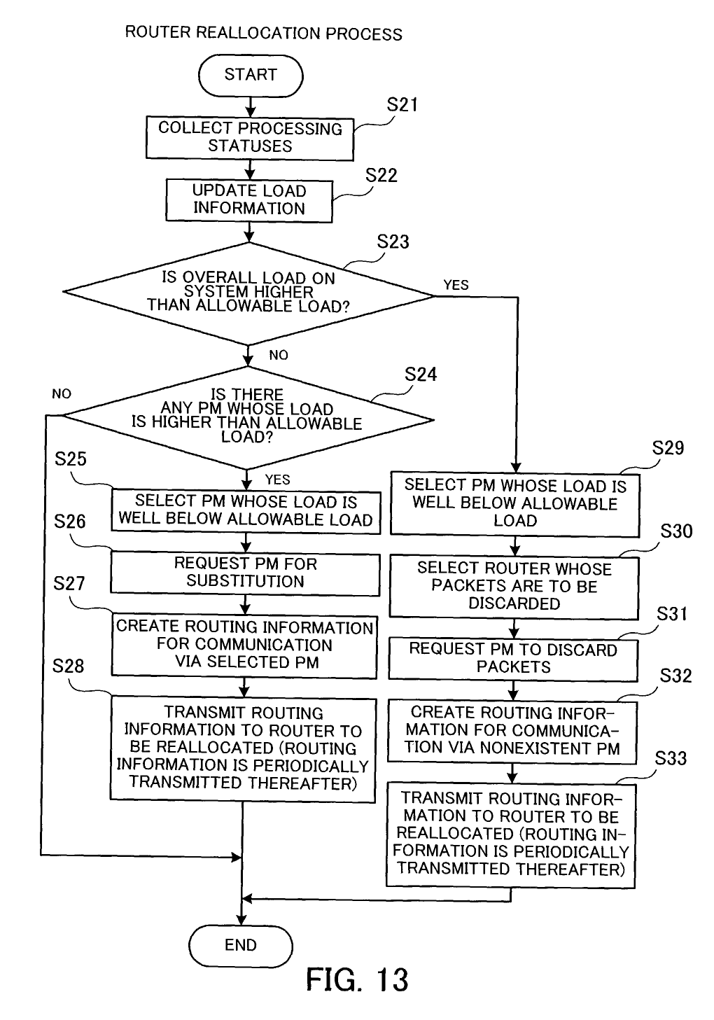

FIG. 13 is a flowchart illustrating a router reallocation procedure. In the following, the process shown in FIG. 13 will be explained in order of the step number. This process is repeatedly executed at predetermined intervals of time.

[Step S21] The load monitoring part 157e of the load control section 157 collects information about the processing status from each of the communication information management sections 136, 146 and 156 of the PMs 130, 140 and 150.

[Step S22] The load monitoring part 157e converts the load on each of the PMs 130, 140 and 150 into a number of connections. Then, the load monitoring part 157e updates the values in the “PRESENT LOAD” column of the load information management table 157b.

[Step S23] The load monitoring part 157e looks up the load information management table 157b to determine whether or not the overall load on the FEP 100 is higher than the corresponding allowable load. If the overall load on the system is higher than the allowable load, the flow proceeds to Step S29; if not, the flow proceeds to Step S24.

[Step S24] The load monitoring part 157e looks up the load information management table 157b to determine whether or not there is a PM whose processing load has exceeded the corresponding allowable load. If such a PM exists, the flow proceeds to Step S25; if there is no such PM, the process is ended.

[Step S25] The load monitoring part 157e looks up the load information management table 157b and selects a PM whose load is well below the allowable load. For example, a PM of which the difference between the allowable load (in terms of the number of connections) and the present load (in terms of the number of connections) is the greatest among the PMs whose present loads are not higher than the respective allowable loads is selected.

[Step S26] The load monitoring part 157e transfers a load reduction request, which includes the PM number of the PM whose processing load has exceeded the allowable load and the PM number of the PM which has been selected in Step S25 (of which the load is well below the allowable load), to the substitution requesting part 157f. The substitution requesting part 157f looks up the router allocation definition table 157a to acquire the IP address of the router allocated to the PM whose load has exceeded the allowable value. Then, the substitution requesting part 157f requests the PM whose load is well below the allowable value to perform the process instead.

[Step S27] The communication information management section of the PM which has received the substitution request transfers the IP address of the newly allocated router and the IP address of the PM to which this router has been allocated so far, to the routing processing section. Thereupon, the routing processing section generates routing information for communication via the selected PM, destined for the router to be reallocated. The routing information includes information indicating that the communication via the PM whose load has exceeded the allowable load is not available.

[Step S28] The routing processing section transfers the generated routing information to the client-side communication section. The client-side communication section transmits the routing information to the router which is to be reallocated, and the process is ended. The routing information is periodically transmitted thereafter.

[Step S29] The load monitoring part 157e looks up the load information management table 157b and selects a PM whose load is well below the allowable load. Then, the load monitoring part 157e transfers a load reduction request to the packet discard requesting part 157g.

[Step S30] The packet discard requesting part 157g looks up the router priority order table 157ca, and selects a router which has the lowest priority level among the routers (status: “COMMUNICATION PERMITTED”) whose packets are not being discarded.

[Step S31] The packet discard requesting part 157g looks up the packet discarding IP address 157cb and thus recognizes the IP address for discarding packets. Then, the packet discard requesting part 157g requests the PM whose load is well below the allowable load to discard packets.

[Step S32] The communication information management section of the PM whose load is well below the allowable load transfers, to the routing processing section, the packet discarding IP address and the IP address of the router which is to be reallocated to the nonexistent PM. Using the address of the router to be reallocated as a destination, the routing processing section generates routing information for communication via the nonexistent PM. The routing information includes information indicating that the communication via the PM to which the router concerned has been allocated so far is not available.

[Step S33] The routing processing section transfers the generated routing information to the client-side communication section. The client-side communication section transmits the routing information to the router which is to be reallocated, and the process is ended. The routing information is periodically transmitted thereafter.

Concrete examples of routing information will be now described.

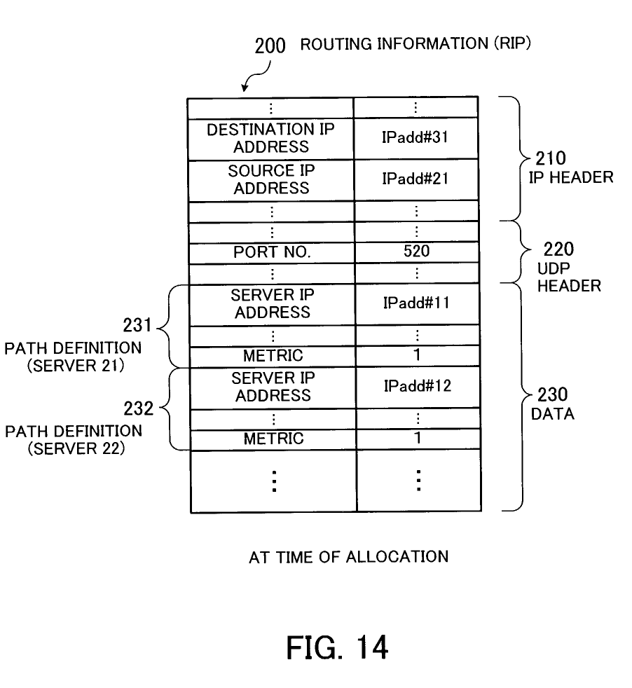

FIG. 14 shows an example of routing information for a router to be allocated to a PM. The routing information 200 is information which the PM 130 transmits to the router 31 allocated thereto.

The routing information 200 is constituted by an IP header 210, a UDP (User Datagram Protocol) header 220, and data 230.

The IP header 210 includes a destination IP address and a source IP address. In the illustrated example, the IP address “IPadd#31” of the router 31 is set as the destination IP address. Also, the IP address “IPadd#21” (communication adapter 120 side) of the PM 130 is set as the source IP address.

The UDP header 220 includes a port number. In the illustrated example, “520” is set as the port number, and the port number “520” indicates that the packet including this routing information 200 is RIP.

As the data 230, path definitions 231, 232, . . . for the respective servers are registered. Each of the path definitions 231, 232, . . . includes a server IP address and a metric. The metric represents the distance (number of relay routers) to the corresponding server and a valid value thereof is in the range of “1” to “15.” In the case where “16” is set as the metric, then it means that the communication with the corresponding server is unavailable.

In the illustrated example, for the path definition 231 corresponding to the server 21, the IP address “IPadd#11” of the server 21 is set as the server IP address. Also, “1” is set as the metric for the path definition 231 corresponding to the server 21. For the path definition 232 corresponding to the server 22, the IP address “IPadd#12” of the server 22 is set as the server IP address. Also, “1” is set as the metric for the path definition 232 corresponding to the server 22. Where the path definition corresponding to the other server similarly includes a valid metric value falling within the range of “1” to “15,” the individual servers 21 to 23 can be accessed via the PM 130, which is a source of the routing information.

The routing information structured as described above is transmitted only to the router 31 allocated to the PM 130, whereby access to the servers 21 to 23 via the PM 130 is available only to the router 31. As a result, packets output from the router 31 and directed to the servers 21 to 23 are transferred thereafter via the PM 130.

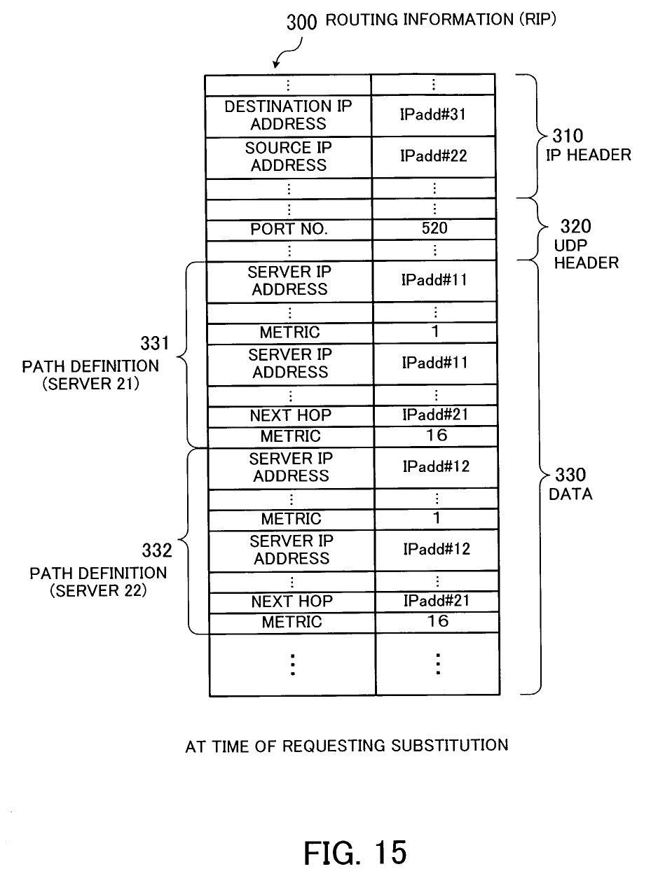

FIG. 15 shows an example of routing information for a router which is to be reallocated from a different PM. The routing information 300 is information which the PM 140 transmits in order to reallocate the router 31 to the PM 140 from the PM 130.

The routing information 300 comprises an IP header 310, a UDP (User Datagram Protocol) header 320, and data 330.

The IP header 310 includes a destination IP address and a source IP address. In the illustrated example, the IP address “IPadd#31” of the router 31 is set as the destination IP address, and the IP address “IPadd#22” (communication adapter 120 side) of the PM 140 is set as the source IP address.

The UDP header 320 includes a port number, and in the illustrated example, “520” is set as the port number. As the data 330, path definitions 331, 332, . . . for the respective servers are registered. Each of the path definitions 331, 332, . . . has a data set including a server IP address and a metric, and a data set including a server IP address, a next hop and a metric.

In the illustrated example, for the path definition 331 corresponding to the server 21, the IP address “IPadd#11” of the server 21 and the metric “1” are set in the data set including a server IP address and a metric, and the IP address “IPadd#11” of the server 21, the IP address “IPadd#21” of the PM 130 and the metric “16” are set in the data set including a server IP address, a next hop and a metric. For the path definition 332 corresponding to the server 22, the IP address “IPadd#12” of the server 22 and the metric “1” are set in the data set including a server IP address and a metric, and the IP address “IPadd#12” of the server 22, the IP address “IPadd#21” of the PM 130 and the metric “16” are set in the data set including a server IP address, a next hop and a metric.

The routing information 300 structured as described above is transmitted only to the router 31 allocated to the PM 130, whereby the router 31 can recognize that access to the servers 21 to 23 via the PM 130 is no longer available and that access to the servers 21 to 23 via the PM 140 is available instead. Namely, in the path definition for each server, “16” is set as the metric for the PM 130 which is the next hop, so that the router 31 recognizes that the servers 21 to 23 do not exist on the path via the PM 130. As a result, packets output from the router 31 and directed to the servers 21 to 23 are transferred thereafter via the PM 140.

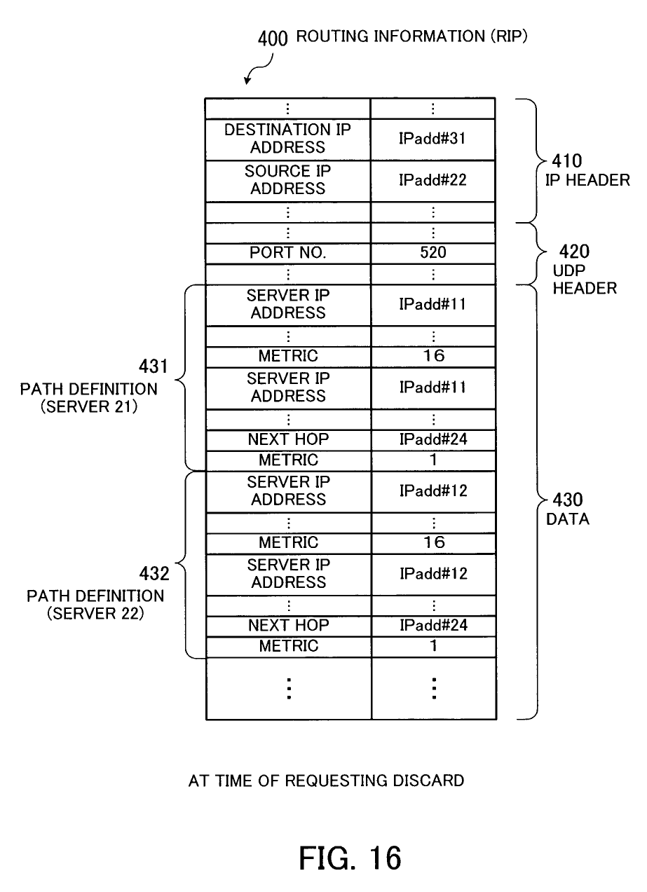

FIG. 16 shows an example of routing information for a router whose packets are to be discarded. The routing information 400 is information which the PM 140 transmits in order to reallocate the router 31 to the PM (PM#4) that actually does not exist. This routing information is output when a decision has been made that the packets received via the router 31 should be discarded.

The routing information 400 includes an IP header 410, a UDP (User Datagram Protocol) header 420, and data 430.

The IP header 410 includes a destination IP address and a source IP address. In the illustrated example, the IP address “IPadd#31” of the router 31 is set as the destination IP address, and the IP address “IPadd#22” (communication adapter 120 side) of the PM 140 is set as the source IP address.

The UDP header 420 includes a port number, and in the illustrated example, “520” is set as the port number. As the data 430, path definitions 431, 432, . . . for the respective servers are registered. Each of the path definitions 431, 432, . . . has a data set including a server IP address and a metric, and a data set including a server IP address, a next hop and a metric.

In the illustrated example, for the path definition 431 corresponding to the server 21, the IP address “IPadd#11” of the server 21 and the metric “16” are set in the data set including a server IP address and a metric, and the IP address “IPadd#11” of the server 21, the IP address “IPadd#24” of the nonexistent PM (PM#4) and the metric “1” are set in the data set including a server IP address, a next hop and a metric. For the path definition 432 corresponding to the server 22, the IP address “IPadd#12” of the server 22 and the metric “16” are set in the data set including a server IP address and a metric, and the IP address “IPadd#12” of the server 22, the IP address “IPadd#24” of the nonexistent PM (PM#4) and the metric “1” are set in the data set including a server IP address, a next hop and a metric.

The routing information 400 structured as described above is transmitted only to the router 31 allocated to the PM 130, whereby the router 31 recognizes that access to the servers 21 to 23 via the PM 130 is no longer available and that access to the servers 21 to 23 via the nonexistent PM (PM#4) is available instead. Namely, in the path definition for each server, “1” is set as the metric for the nonexistent PM (PM#4) which is the next hop, and accordingly, the router 31 recognizes that the distance to the servers 21 to 23 through the path via the nonexistent PM (PM#4) is the shortest. As a result, packets output from the router 31 and directed to the servers 21 to 23 are thereafter transferred to the nonexistent PM (PM#4) and thus are discarded in the FEP 100.

As described above, according to this embodiment, the routing information to be transmitted from the PMs is controlled, and this makes it possible to control the amount of IP packets that each PM of the FEP receives. Thus, even in cases where massive amounts of data are received from many different originators, communications of higher priority can be assured.

If communications from the originators (clients 51 to 58) are concentrated to a higher level than expected, the process required surpasses the capabilities of the FEP 100. In such cases, the destination of packets as viewed from the side of the routers 31 to 34 (the gateway for the routing information in the routers 31 to 34) is temporarily redirected to the MAC address/IP address that is not used for communication purposes. This makes it possible to lighten the overall load on the FEP 100 and to ensure communications concerned with transactions or originators of higher priority.

The processing function described above can be performed by a computer. In this case, a program is prepared in which are described processes for performing the function of the front-end processor. The program is executed by a computer, whereupon the aforementioned processing function is accomplished by the computer. The program describing the processes may be recorded on a computer-readable recording medium. The computer-readable recording medium includes magnetic recording device, optical disk, magneto-optical recording medium, semiconductor memory, etc. Such a magnetic recording device may be hard disk drive (HDD), flexible disk (FD), magnetic tape, etc. As the optical disk, DVD (Digital Versatile Disc), DVD-RAM (Random Access Memory), CD-ROM (Compact Disc Read Only Memory), CD-R (Recordable)/RW (ReWritable) or the like may be used. The magneto-optical recording medium includes MO (Magneto-Optical disc) etc.

To distribute the program, portable recording media, such as DVD and CD-ROM, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer. Then, the computer loads the program from its storage device and performs processes in accordance with the program. The computer may load the program directly from the portable recording medium to perform processes in accordance with the program. Also, as the program is transferred from the server computer, the computer may sequentially perform processes in accordance with the program.

As described above, according to the present invention, a router on the first network is allocated to routing means, and routing information indicative of the communication path to a server computer on the second network via the routing means is transmitted to the allocated router. Accordingly, only the allocated router can access the server computer via the routing means as instructed by the routing information. This enables the front-end processor to manage the processing load of the routing means.

Also, according to the present invention, the load on the routing means for performing routing is monitored, and if the load exceeds a predetermined value, at least part of packets output from a predetermined router on the first network are discarded. Thus, in cases where the load has become excessively high, packets are discarded, whereby the response speed of the system as a whole can be prevented from being lowered.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A front-end processor for routing packets, comprising:
routing means for routing packets input via a first network to a second network;
allocating means for allocating a router on the first network to said routing means; and
routing information transmitting means for transmitting routing information indicative of a communication path to a server computer on the second network via said routing means, to the router allocated by said allocating means.

2. The front-end processor according to claim 1, further comprising:
load determining means for monitoring a load on said routing means and determining whether or not the load has exceeded a predetermined value; and
packet discarding means for discarding at least part of packets output from the router if it is judged by said load determining means that the load on said routing means has exceeded the predetermined value.

3. A front-end processor for routing packets, comprising:
a plurality of routing means each for routing packets input via a first network to a second network;
allocating means for allocating routers on the first network to corresponding ones of said plurality of routing means; and
routing information transmitting means for transmitting routing information necessary for communicating with a server computer on the second network via each of said routing means, to a corresponding one of the routers on the first network allocated to said routing means by said allocating means.

4. The front-end processor according to claim 3, further comprising load determining means for monitoring loads on said plurality of routing means and identifying high loaded routing means whose load has exceeded a predetermined value, and wherein
said allocating means reallocates that router on the first network which is allocated to said high loaded routing means identified by said load determining means, to a different one of said routing means.

5. The front-end processor according to claim 4, wherein said routing information transmitting means transmits, in response to the router reallocation by said allocating means, routing information necessary for communicating with the server computer on the second network via said different routing means, to said router allocated to said high loaded routing means.

6. The front-end processor according to claim 5, wherein said routing information transmitted to said router allocated to said high loaded routing means includes information indicating that communication via said high loaded routing means is unavailable.

7. The front-end processor according to claim 3, further comprising:
load determining means for monitoring loads on said plurality of routing means and determining whether or not an overall load on said plurality of routing means has exceeded a predetermined value; and
packet discarding means for discarding at least part of packets output from the routers on the first network if it is judged by said load determining means that the overall load on said plurality of routing means has exceeded the predetermined value.

8. The front-end processor according to claim 7, wherein, if it is judged by said load determining means that the overall load on said plurality of routing means has exceeded the predetermined value, said packet discarding means transmits, to one of the routers, routing information for communicating with the server computer on the second network via a path that actually does not exist.

9. A front-end processor for routing packets, comprising:
routing means for routing packets input via a first network to a second network;
load determining means for monitoring a load on said routing means and determining whether or not the load has exceeded a predetermined value; and
packet discarding means for discarding at least part of packets to be routed by said routing means if it is judged by said load determining means that the load on said routing means has exceeded the predetermined value.

10. The front-end processor according to claim 9, wherein, if it is judged by said load determining means that the load on said routing means has exceeded the predetermined value, said packet discarding means transmits, to a router on the first network, routing information for communicating with a server computer on the second network via a path that actually does not exist.

11. A routing management method for managing routing of packets from a first network to a second network, comprising:
allocating a router on the first network to a relay path connecting between the first and second networks; and
transmitting, to the allocated router, routing information indicative of a communication path to a server computer on the second network via the relay path.

12. A routing management method for managing routing of packets from a first network to a second network, comprising:
monitoring a load on a relay path for performing routing; and
discarding at least part of packets output from a predetermined router on the first network if the load on the relay path has exceeded a predetermined value.

13. A routing management program for managing routing of packets from a first network to a second network,
wherein said routing management program causes a computer to perform the process of:
allocating a router on the first network to a relay path connecting between the first and second networks; and
transmitting, to the allocated router, routing information indicative of a communication path to a server computer on the second network via the relay path.

14. A routing management program for managing routing of packets from a first network to a second network,
wherein said routing management program causes a computer to perform the process of:
monitoring a load on a relay path for performing routing; and
discarding at least part of packets output from a predetermined router on the first network if the load on the relay path has exceeded a predetermined value.

15. A computer-readable recording medium having a routing management program recorded thereon for managing routing of packets from a first network to a second network,
wherein said routing management program causes the computer to perform the process of:
allocating a router on the first network to a relay path connecting between the first and second networks; and
transmitting, to the allocated router, routing information indicative of a communication path to a server computer on the second network via the relay path.

16. A computer-readable recording medium having a routing management program recorded thereon for managing routing of packets from a first network to a second network,
wherein said routing management program causes the computer to perform the process of:
monitoring a load on a relay path for performing routing; and
discarding at least part of packets output from a predetermined router on the first network if the load on the relay path has exceeded a predetermined value.
